(19) United States
(12) Patent Application Publication
(10) Pub. No.: US 2020/0404540 A1
(43) Pub. Date: Dec. 24, 2020

(54) SYSTEMS AND METHODS FOR COMBINED MANAGEMENT WITH USER PREFERENCES OF WI-FI AND CELLULAR DATA

(71) Applicant: ASSIA SPE, LLC, Wilmington, DE (US)

(72) Inventor: Kenneth J. Kerpez, Long Valley, NJ (US)

(73) Assignee: ASSIA SPE, LLC, Wilmington, DE (US)

(21) Appl. No.: 16/900,940

(22) Filed: Jun. 14, 2020

Related U.S. Application Data
(60) Provisional application No. 62/864,869, filed on Jun. 21, 2019.

(51) Int. Cl. H04W 28/08; H04W 28/10; H04W 28/02; H04W 36/22

(52) U.S. Cl. CPC H04W 28/0925; H04W 28/10; H04W 84/12; H04W 36/22; H04W 28/0268

(57) ABSTRACT

Various embodiments of the invention relate to system and method for combined management with user preferences of Wi-Fi and cellular data. The system presents diagnostics data to users in one or more ways showing the impact on their applications, and allows the user to provide high-level control of the use of the two or more connections. Embodiments of the system diagnose both Wi-Fi/broadband and cellular data; at both low layers, such as physical, link, or network layers; and high layers, such as session, presentation, or application layers. Joint cellular data and Wi-Fi diagnostics are determined, and the impact of the diagnostics to application performances may also be shown. Recommendations may be further provided for network policies and configurations aimed at the user's preferences and applications.

### CROSS-REFERENCE To RELATED APPLICATION

This application claims the priority benefit under 35 USC § 119(e) to U.S. Provisional Patent Application No. 62/864,869 (Docket No. 20145-119P), filed on Jun.21, 2019, entitled “Systems and Methods for Combined Management with User Preferences of Wi-Fi and Cellular Data”, and listing Kenneth J. Kerpez as the inventor. The aforementioned patent document is incorporated by reference herein in its entirety.

### BACKGROUND

### A. Technical Field

The present invention relates generally to system and methods for wireless communication, and more particularly to systems and methods for joint management among different wireless communication modes.

### B. Background of the Invention

Wireless communication is a type of communication to permit a device to communicate wirelessly using radio waves with another device. It has become an integrated part of serving people's communication needs. A mobile device may support one or more types of wireless communication, include cellular communication, Wi-Fi, or Bluetooth, et al.

A mobile device, such as a smartphone or a tablet, may be able to switch between communication modes, or even adopt multiple wireless communication modes to support one or more applications. Internet access may generally be accessible to a mobile device via two types of networks, Wi-Fi or cellular data. Wi-Fi or other local wireless networks are more generally called Wireless Local Area Network (WLAN). A WLAN is generally at the end of a broadband access line, or sometimes another type of Wide Area Network (WAN) or Local Area Network (LAN). Cellular data may encompass 3G, 4G, 5G, LTE, LTE-advanced, new radio (NR) and/or similar future systems. For example, a cellular phone may use either a cellular network or Wi-Fi for data communication, or use a cellular network for voice communication while simultaneously using Wi-Fi for data communication.

It is often the case that a mobile device such as a smartphone or tablet; or a Hybrid Customer Premises Equipment (HCPE), may access the Internet by both types of networks. There are currently various mechanisms in use where the equipment determines which of these two networks to use. There are also mechanisms specified, although not yet in general use, for simultaneous use of both networks.

However, the management of traffic across these networks has not been considered, and while the user perceives that both networks exist, their relative usage and the resulting impact on applications and services is entirely opaque with no understanding or control by users.

Furthermore, in certain situations, the usage of different wireless communication modes may have interference. A management policy may be necessary to coordinate between various communication modes according to user desirability. However, the preference setting may be a predetermined setting instead of a setting based on analysis results. As a result, such a preference setting may not be optimized to serve the user's needs.

What is needed are systems, and methods for joint management among different wireless communication modes based on network diagnostics.

### SUMMARY OF THE INVENTION

The invention relates to system and method for combined management with user preferences of Wi-Fi and cellular data. The system presents diagnostics data to users in one or more ways showing the impact on their applications, and allows the user to provide high-level control of the use of the two or more connections. Embodiments of the system diagnose both Wi-Fi/broadband and cellular data; at both low layers, such as physical, link, or network layers; and at high layers, such as session, presentation, or application layers. Joint cellular data and Wi-Fi diagnostics are determined, and the impact of the diagnostics to application performances may also be shown. Recommendations may be further provided for network policies and configurations aimed at the user's preferences and applications.

Embodiments of a system for combined management of both Wi-Fi and cellular data connections are described herein. The system may present diagnostics data to users in a simple way showing the impact on their applications, and allow the user to provide high-level control of the use of the two or more connections for providing their applications.

In one or more embodiments, the system displays diagnostics to a user showing how their connections between cellular data and Wi-Fi have been operating and changing, the quality of these connections, and the performance of applications running on these connections. In one or more embodiments, the system allows a user to vary connection control to approach the desired performance related to one or more application. The system may manage how traffic is switched across either connection, or sent across both connections simultaneously with multipath access.

In one or more embodiments, the system diagnoses both Wi-Fi/broadband and cellular data, at both low layers (physical, link, network) and high layers (session, presentation, application). Joint cellular data and Wi-Fi diagnostics are implemented, and the system shows how these diagnostics impact applications performances.

In one or more embodiments, the system may further provide recommendations for network policies and configurations. The configuration is aimed at the user's preferences and applications. The system may control roaming, with a simple display of diagnostics, applications and connections. The user may specify a high-level policy of broad preferences for applications, services and Wi-Fi versus cellular data usage. The system receives this policy, reads network and application conditions, and then performs an analysis to determine diagnostics relative to the user specified preferences. In one or more embodiments, recommendations may be made with consideration of various parameters, such as usage caps and pricing. The system may further issue recommendations or issue instructions to re-configure the device, networks and services.

In one or more embodiments, the system enables a user to oversee the quality provided for an application, such as voice service. Depending on location and connection type to a Wi-Fi, AP, or cellular base station, the service quality may vary considerably due to the implemented applications using the connected network. The system may present a simplified view to the user showing how some connections, locations, or configurations give poor service. The system may further re-configure network support for the application, for example by favoring Wi-Fi or cellular, by increasing bandwidth, or by reducing or pausing activities of other applications, by changing device settings, etc.

In one or more embodiments, the system may comprise one or more software modules, which may run in the cloud, in apps or agents on a mobile device, or both in the cloud and on the device.

### BRIEF DESCRIPTION OF THE DRAWINGS

Reference will be made to exemplary embodiments of the present invention that are illustrated in the accompanying figures. Those figures are intended to be illustrative, rather than limiting. Although the present invention is generally described in the context of those embodiments, it is not intended by so doing to limit the scope of the present invention to the particular features of the embodiments depicted and described.

FIG. (“FIG.”) 1 shows a prior art diagram illustrating Open Systems Interconnection (OSI) layers.

FIG. 2A shows cellular data and Wi-Fi/broadband network combinations for a separate networks architecture according to various embodiments of the invention.

FIG. 2B shows cellular data and Wi-Fi/broadband network combinations for an integrated core network architecture according to various embodiments of the invention.

FIG. 2C shows alternative cellular data and Wi-Fi/broadband network combinations for an integrated access network architecture according to various embodiments of the invention.

FIG. 3 shows components of a combined management system for Wi-Fi and cellular data according to various embodiments of the invention.

FIG. 4 shows use of cloud computing and apps/agent infrastructures according to various embodiments of the invention.

FIG. 5 shows a diagnostics flow chart according to various embodiments of the invention.

FIG. 6A shows a flow chart for an open-loop configuration according to various embodiments of the invention.

FIG. 6B shows a flow chart for a closed-loop configuration according to various embodiments of the invention.

FIG. 7 shows a flow chart for a location-based combined management according to various embodiments of the invention.

One skilled in the art will recognize that various implementations and embodiments of the invention may be practiced in accordance with the specification. All of these implementations and embodiments are intended to be included within the scope of the invention.

### DETAILED DESCRIPTION OF THE PREFERRED EMBODIMENTS

In the following description, for purpose of explanation, specific details are set forth in order to provide an understanding of the present invention. The present invention may, however, be practiced without some or all of these details. The embodiments of the present invention described below may be incorporated into a number of different electrical components, circuits, devices, and systems. Structures and devices shown in block diagram are illustrative of exemplary embodiments of the present invention and are not to be used as a pretext by which to obscure broad teachings of the present invention. Connections between components within the figures are not intended to be limited to direct connections. Rather, connections between components may be modified, re-formatted, or otherwise changed by intermediary components.

When the specification makes reference to “one embodiment” or to “an embodiment” it is intended mean that a particular feature, structure, characteristic, or function described in connection with the embodiment being discussed is included in at least one contemplated embodiment of the present invention. Thus, the appearance of the phrase, “in one embodiment,” in different places in the specification does not constitute a plurality of references to a single embodiment of the present invention.

The use of certain terms in various places in the specification is for illustration and should not be construed as limiting. A service, function, or resource is not limited to a single service, function, or resource; usage of these terms may refer to a grouping of related services, functions, or resources, which may be distributed or aggregated.

The terms “include,” “including,” “comprise,” and “comprising” shall be understood to be open terms and any lists the follow are examples and not meant to be limited to the listed items. Each reference mentioned in this patent document is incorporate by reference herein in its entirety.

Furthermore, one skilled in the art shall recognize that: (1) certain steps may optionally be performed; (2) steps may not be limited to the specific order set forth herein; (3) certain steps may be performed in different orders; and (4) certain steps may be done concurrently.

FIG. 1 shows a prior art diagram illustrating Open Systems Interconnection (OSI) layers. Communication networks rely on principles of layer separation. For example, lower networking layers (layer 1 to layer 4) need not interact with the application at higher layers (layer 5 to layer 7). The application layer is often called the service layer, and the presentation layer is often part of the application/service layer. Herein, “low layers” refers to layer 1 to layer 4, and “high layers” refers to layer 5 to layer 7.

One principle of networking is that multiple links (physical and link layer 1 and 2) may be used in a communication path to support services at higher layers (e.g., presentation and application layers 6 and 7) while only considering end-to-end network performance without any need to worry about the individual links.

One or more embodiments of this invention instead relates user-input at the application, presentation, and session layer to lower layer physical, link, and network performances. Embodiments of a joint management system involve the impact of the lower layers of both the cellular network, and the Wi-Fi network, on user applications. Embodiments of the joint management further relate applications to the diagnostics and configuration of physical, link, and network layers of both the cellular network, and the Wi-Fi network. Embodiment of the system may allow a user to manage the impact of cellular and Wi-Fi network diagnostics and traffic at the application layer.

Described hereinafter are various embodiments of the present patent disclosure related to system and method for combined management with user preferences of Wi-Fi and cellular data. The system presents diagnostics data to users in one or more ways showing the impact on their applications, and allows the user to provide high-level control of the use of the two or more connections. Embodiments of the system diagnose both Wi-Fi/broadband and cellular data, at both low layers, such as physical, link, or network layers, and high layers, such as session, presentation, or application layers. Joint cellular data and Wi-Fi diagnostics are determined, and the impact of the diagnostics to application performances may also be shown. Recommendations may be further provided for network policies and configurations aimed at the user's preferences and applications.

In one or more embodiments, the combined management system is usable and accessible by a mobile device user, and provides access management across disparate wireless network domains, e.g. cellular and Wi-Fi/broadband. Aspects unique to services delivery to the devices mobile device via broadband networks and Wi-Fi are considered. One or more services-aware joint configurations are evaluated. As a comparison, previous control was limited to rigid definitions of diagnostics and parameter settings controlled by operators and equipment, but not influenced by users or their demand for applications.

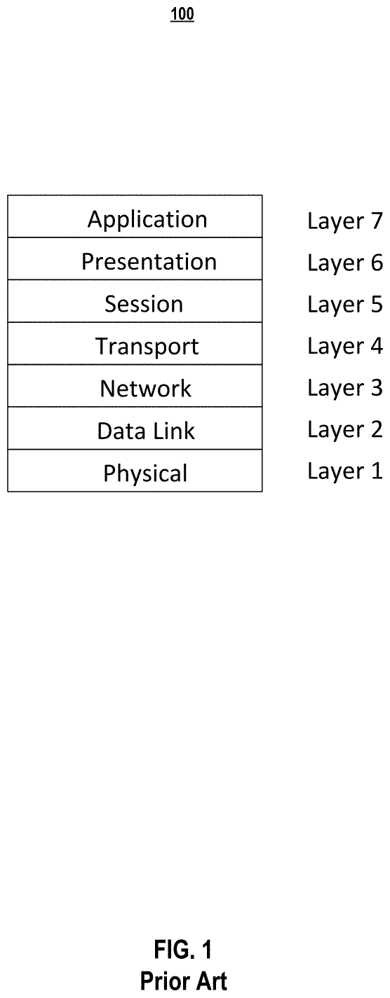

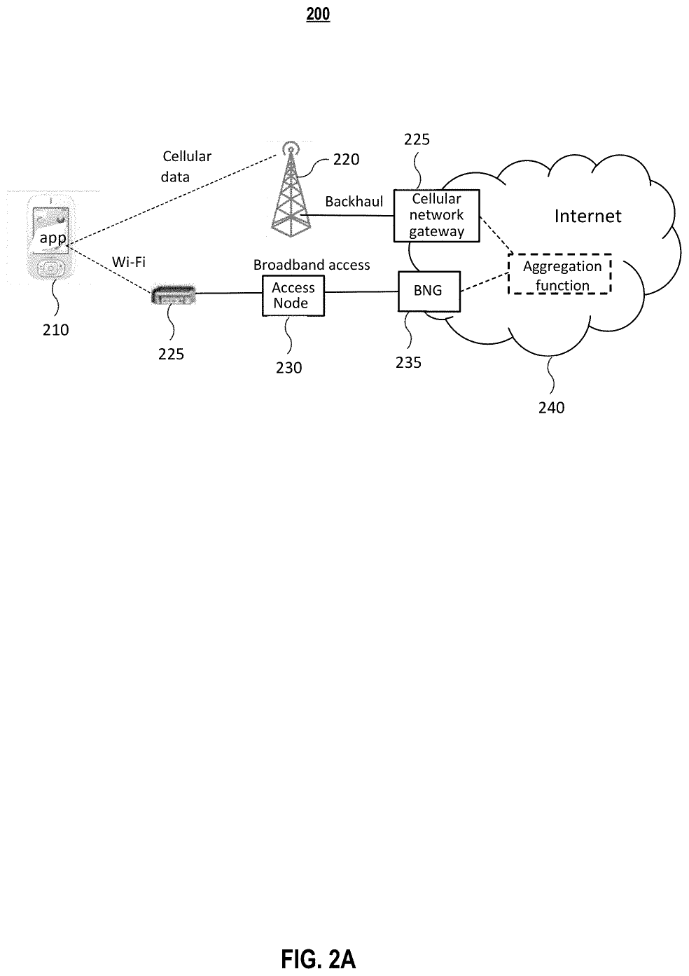

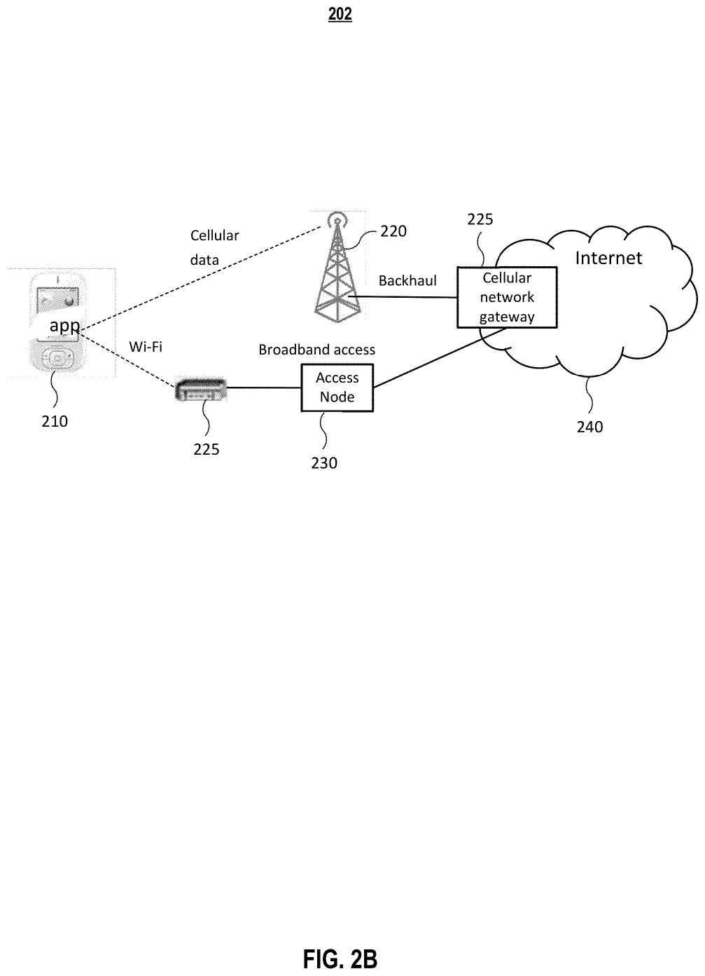

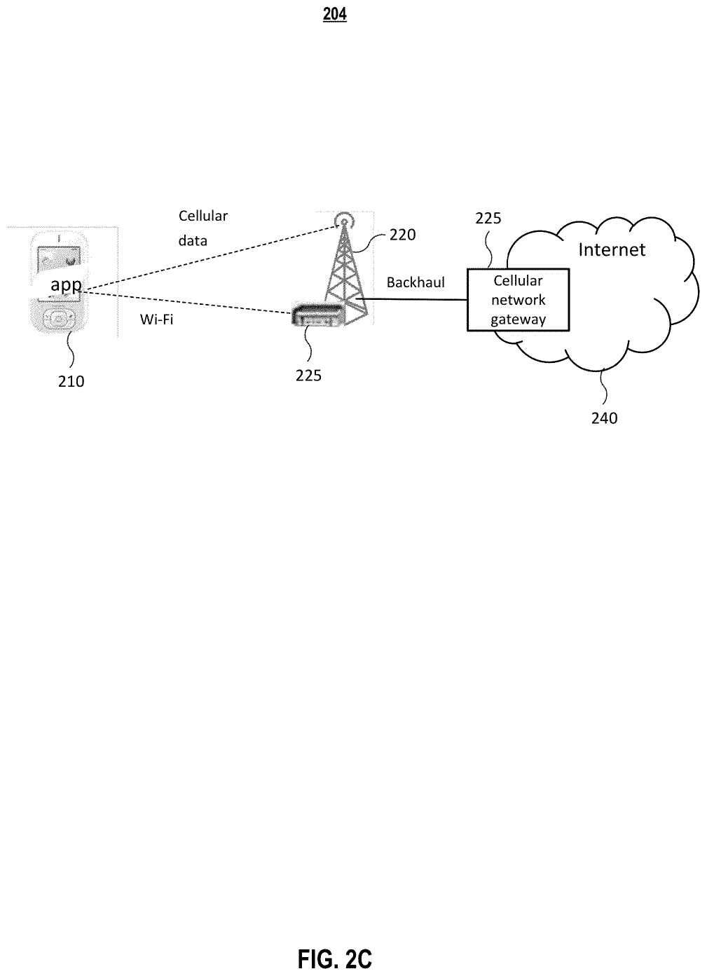

FIGS. 2A, 2B and 2C show cellular data and Wi-Fi/broadband network combinations for separate networks architecture, integrated core network architecture, and integrated access network architecture, respectively, according to various embodiments of the invention. As shown in FIGS. 2A-2C, a mobile device 210 couples to a wireless cell tower 220 via a cellular data link and to a WLAN 225 via a Wi-Fi link. The wireless cell tower 220 couples to a cellular network gateway (CNG) 225 and thus the Internet 240 via backhaul connection. The CNG 225 is sometimes called an Access Gateway Function (AGF). The WLAN 225 may couple to a Broadband Network Gateway (BNG) 235 and thus the Internet 240 via a broadband access node 230, as shown in FIG. 2A; or the WLAN 225 may couple to the cellular network gateway 225 for internet connection via the broadband access node 230, as shown in FIG. 2B; or the WLAN 225 may couple to the cellular network gateway 225 via backhaul connection, as shown in FIG. 2C. The Aggregation Function in FIG. 2A is sometimes called a Fixed Mobile Interworking Function (FMIF).

In one or more embodiments, aggregation can be performed, e.g. at the Ethernet layer, IP layer, session layer, application layer, or Packet Data Convergence Protocol (PDCP) layer. Multipath access may send data across both Wi-Fi and cellular data links, and across multiple Wi-Fi, cellular data, and wired links. Data communication may be similarly switched or apportioned across multiple bands or channels of Wi-Fi or of cellular data. This may be done in both traffic directions: upstream and downstream, or uplink and downlink. Traffic prioritization and separation may be configured. Multipath TCP (MPTCP) may be controlled by a combined management system. Network partitions or network slices may be configured.

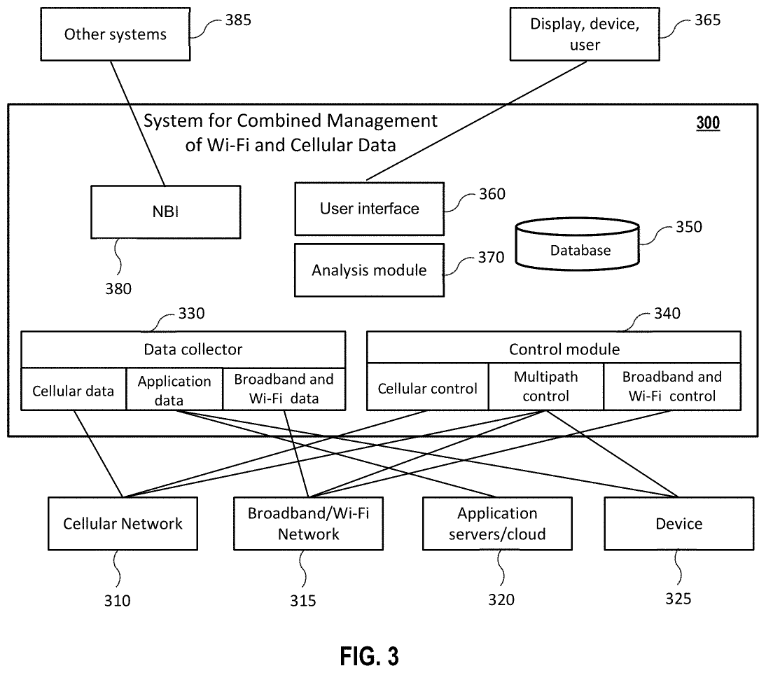

FIG. 3 shows components of a combined management system 300 for Wi-Fi and cellular data according to various embodiments of the invention. The system 300 comprises a data collection module or data collector 330, a control module 340, a data base 350, a user interface 360, an analysis module 370, and one or more Northbound interfaces (NBIs) 380 coupled to other systems 385. The data collector 330 collects cellular data from a cellular network 310, broadband (or Wi-Fi) data from a Wi-Fi network 315, and application data from application server (or cloud server) 320 and/or the mobile device 325. The combined management system 300 may further receive input from a user 365 via the user interface 360 for user preference, desired settings, quality performance feedback, etc. The analysis module 370 implements separate analysis and/or joint analysis for collected cellular data, broadband or Wi-Fi data and application data. Based on analysis result, the control module 340 generates cellular control data for cellular network control, broadband or Wi-Fi control data for Wi-Fi network control, multipath control data for combined data path control of the cellular network and the Wi-Fi network. The database 350 stores collected data, analysis results, user preferences, and/or historic data etc. In one or more embodiments, the database 350 may be accessible by the data collector 330 for collected data storage, and by the analysis module 370 to provide information needed for analysis. In one or more embodiments, the database 350 may be in a server, or a cloud database running on a cloud computing platform.

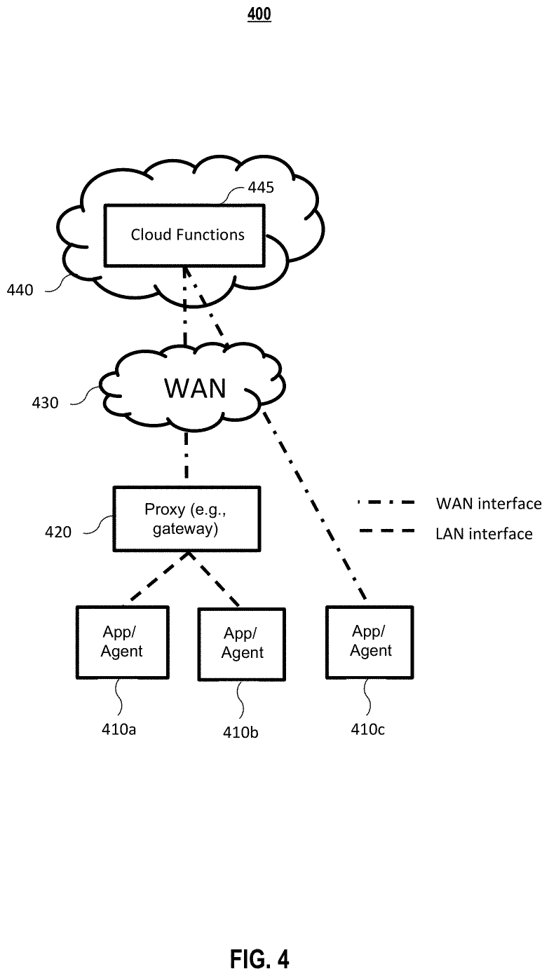

FIG. 4 shows use of cloud computing and apps/agent infrastructures according to various embodiments of the invention. One or more components of the combined management application may be installed within the mobile device as an agent or app 410a-410c. The agent may be coupled to a WAN 430 via a proxy (e.g. gateway) 420 through a LAN interface or directly to the WAN 430 through a WAN interface. The WAN 430 couples to the internet via a WAN interface. In one or more embodiments, one or more modules may be run in a cloud platform to provide one or more cloud functions. For example, the analysis module may be a cloud based module to receive information from a data collector locally installed within a mobile device, to implement analysis, and to transmit the analysis result back to a control module, which may also be installed locally within the mobile device, for joint cellular/Wi-Fi control implementation.

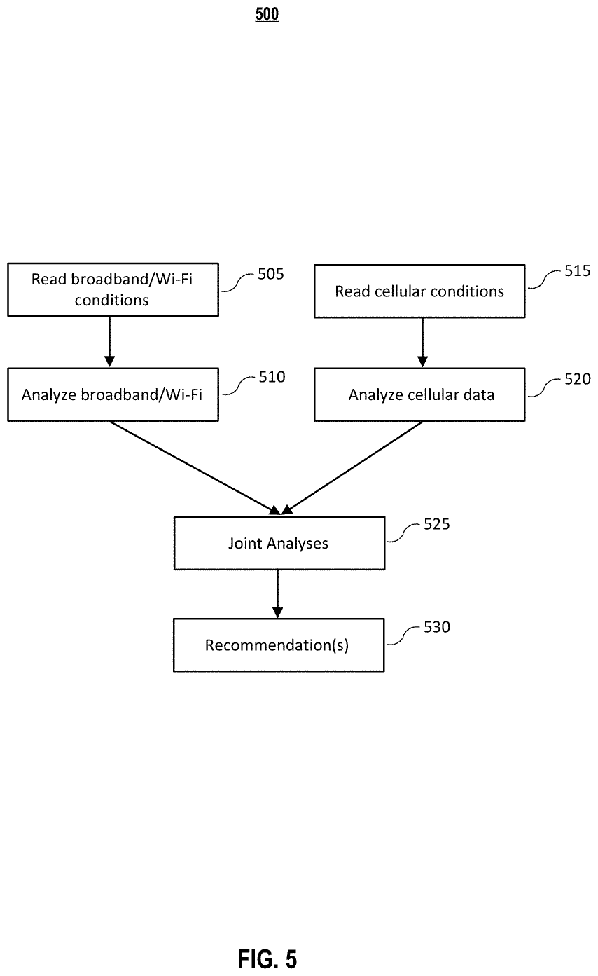

A combined management system 300 receives input of network conditions, capabilities, running applications, traffic load and traffic demand, and user preferences. The system then provides diagnostics on one or more data connections, such as a Wireless Local Area Network (WLAN) or Wi-Fi connection, and a cellular data connection. FIG. 5 shows a diagnostics flow chart according to various embodiments of the invention. Broadband/Wi-Fi conditions are read in step 505 and analyzed in step 510. Similarly, cellular conditions are read in step 515 and analyzed in step 520. In step 525, joint analyses are implemented based on both Wi-Fi analysis and cellular data analysis. In one or more embodiments, the joint analyses are implemented with consideration of additional factors, including user desirability, user action prediction (e.g. user movement trajectory prediction), user historic data, types and priorities of applications operated on the mobile devices, whether any applications involve a trust or authentication transaction, etc. In step 530, one or more recommendations based on the single analysis (510, or 520) and/or joint analysis (525) are presented. In one or more embodiments, the steps 505/510 and step 515/520 may be implemented in parallel or sequentially, depending on system configurations. Although FIG. 5 shows separate analyses for broadband and cellular data followed by joint analyses, one skilled in the art shall understand that the broadband/Wi-Fi conditions read in step 505 and the cellular data read in step 515 may be analyzed together directly in step 525, without analyses separately. Such a variation shall still be within the scope of this invention.

In one or more embodiments, the analyses or diagnostics are simplified and presented to a user in a format that allows the user to understand the impact of these network diagnostics on application performances. For example, the application may show the user that cellular data is good for voice but Wi-Fi is better for streaming video, which results from network diagnostics showing that there is a stable but low-data rate cellular data connection and a high-speed Wi-Fi connection.

In one or more embodiments, the combined management system may further provide an interface for the user to specify or invoke one or more high-level policies to control the joint management of Wi-Fi broadband access and cellular data. In one or more embodiments, the one or more policies may broadly prioritize different services or applications, preferences for the perceived service delivery performance of one or more applications, state preferred behavior if a service cap may be reached or how to handle other pricing implications, specify user quality of experience (QoE) preferences, or specify other application-level indicators. For example, a policy may prioritize voice conversations or music over data or video, prioritize uninterrupted video service over high-quality images, or specify whether to allow additional cellular usage fees or instead move traffic toward Wi-Fi.

In one or more embodiments, user input, network data, and applications support are all input to determine application-based diagnostics. These diagnostics depend on the support needed to run applications according to user desires as well as on the network performances. Diagnostics are presented to a user in an understandable manner or message, e.g., such as an alert that Wi-Fi and/or cellular data cannot support current application requests.

Based on user specified high-level policy desires, network performances, and available options such as roaming; an analysis is performed to determine candidate control actions or re-configurations which can improve user service. These control and configuration actions may be implemented automatically or a high-level choice of actions can be presented to the user who may then affect such actions. As an example, application flow may be re-apportioned between Wi-Fi and cellular data connections. Based on the diagnostics, one or more actions may be implemented in various ways, e.g. in an open-loop configuration or closed-loop configuration.

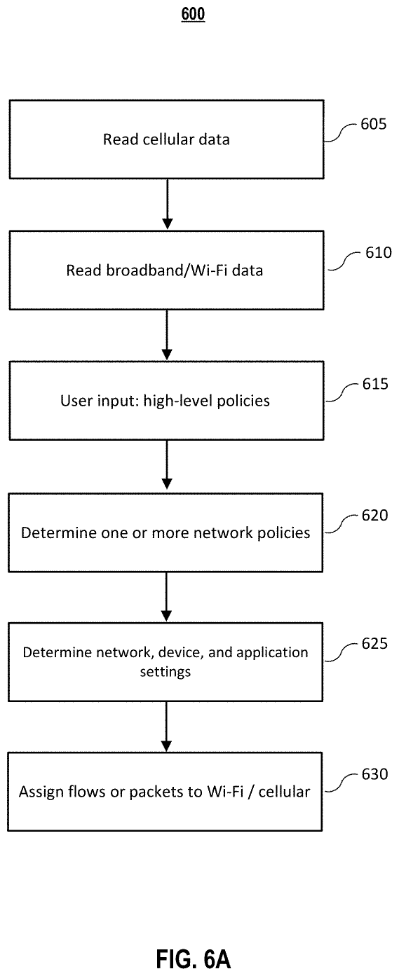

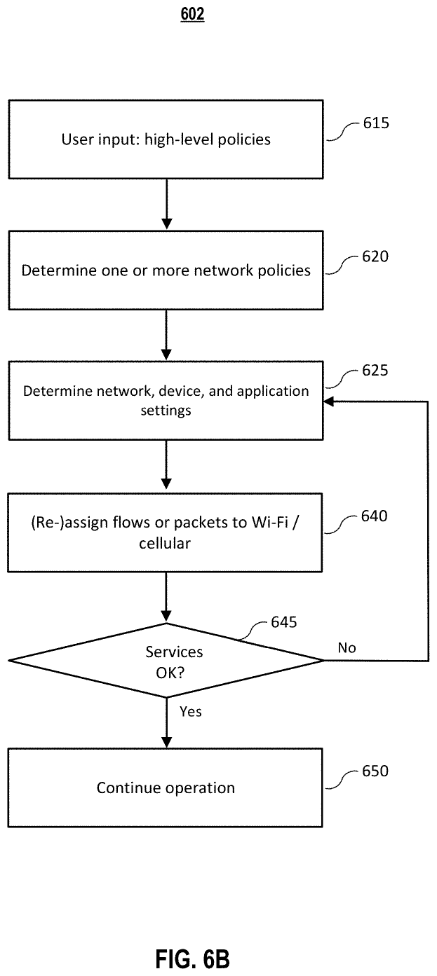

FIG. 6A and FIG. 6B respectively show a flow chart for an open-loop configuration and a closed-loop configuration according to various embodiments of the invention. Some initial steps may be the same for these two configurations. Cellular data are read or collected in step 605 and broadband data are read or collected in step 610. Alternatively, there two steps may be done in parallel instead of sequentially as shown in FIG. 6A. One or more high-level policies are input by the mobile device user in step 615. The high-level policies broadly indicate the user's preferences to support applications or services. The high-level policies, together with the collected Wi-Fi data and cellular data, may be used to determine more detailed network policies and configurations as well as services delivery in step 620. In step 625 one or more network, device, and/or application settings as well as services delivery are determined based at least on the determined network policies. For the open-loop configuration shown in FIG. 6A, in step 630, flow or packet distribution to Wi-Fi and/or cellular network is assigned for implementation.

For the closed-loop configuration shown in FIG. 6B, in step 640, flow distribution to Wi-Fi and/or cellular network is assigned for implementation. The assigned flows or packets are evaluated in step 645 to determine whether the wireless communication services with the assigned flow are satisfactory. The determination may be based on one or more thresholds, such as latency, error rate, etc. If the services are satisfactory, the process goes to step 650 for operation continuing operation. Otherwise, the process goes back to step 625 to re-determine network, device, and application settings policies and configurations as well as services delivery.

### Embodiments of High-level policies

In one or more embodiments, high-level policies may involve a user selecting: high performance (e.g., use cellular data more) or low-cost (e.g., use Wi-Fi more); one or more “thresholds” for using cellular data versus Wi-Fi; assignment of service priorities; be cost or traffic-based; to select or prefer cellular data versus Wi-Fi depending on usage caps, data charging, relative costs; soft selection of a relative desire to use cellular data versus Wi-Fi, e.g., on a sliding scale from 1 to 10. Policies may be overall, per application/service, per classes of services, or a combination of these.

In one or more embodiments, one or more high-level policies may be based on application security type, Wi-Fi security level, etc. Wi-Fi security ratings may be basically rated in the following order from best to worst based on the type of security system:

Wireless Protected Access 3 (WPA3)

Wireless Protected Access 2 (WPA2)+Advanced Encryption Standard (AES)

Wireless Protected Access (WPA)+AES

WPA +TKIP/AES (TKIP is there as a fallback method)

WPA +Temporal Key Integrity Protocol (TKIP)

Wired Equivalent Privacy (WEP)

Open Network (no security at all)

Similarly, the applications installed on the mobile device may also be rated based on security level needed for operation. For example, a trust transaction involving large amount of money transfer may require a high rating for wireless communication, thus it is not desirable for operation using an open Wi-Fi network. While on the other hand, such an open Wi-Fi network may be acceptable for a general news delivery application. The user may designate a high-level security policy for one or more applications operable on the mobile device. Also, the system may apply end-to-end security, such as Transport Layer Security (TLS) or Secure Sockets Layer (SSL), to ensure overall integrity for some applications.

### Embodiments of Network and Application Policies

In one or more embodiments, high-level user policies may drive the determination of low-level network and/or application policies which affect network, device, and application settings and behavior. For example, a high-level policy specifying a preference for Wi-Fi may then cause selection of a network and application policy which specifies under what conditions cellular data may also be used. Pricing/charging may be influenced by policy in one or more embodiments.

Further, depending on the conditions, the system may determine the control and configuration of actual network device and link parameter settings and data-plane forwarding.

### Embodiments of Conditions

In one or more embodiments, conditions may include environmental conditions, network demand, application demand, user-desired applications, traffic load, traffic levels, network links, equipment conditions, user demands, user preferences, error or fault conditions; and link, network, application and device capabilities, current network conditions, historical network conditions, performances, fault conditions, equipment and network capabilities; current configurations, historical data and trends of any of these. In one or more embodiments, conditions may be stored in a database or obtained from messages; conditions may be separated or aggregated across multiple users, equipment and network segments; conditions may be recorded at separate times and locations.

In one or more embodiments, conditions may be read from network elements, probes, devices, applications, or service origination functions. Conditions may also be read with passive data queries, active probing, or speed tests.

### Embodiments of Analyses

In one or more embodiments, one or more analyses in step 510, 520 and / or 530 may be implemented based at least on input conditions and may determine distilled diagnostics data such as determining root causes, reasons for poor performance, congestion levels, bottlenecks, inability to satisfy demand, user perceived quality. Analyses may be used with application demands and policies to analyze “what if” conditions such as what happens if more data is routed over the cellular data network. In one or more embodiments, Artificial Intelligence (AI) or Machine Learning (ML) may be employed in the system to perform analyses and to improve on recommendations.

### Embodiments of Diagnostics

Diagnostics result from conditions and analyses. In one or more embodiments, diagnostics may be aimed at providing information to application or service providers, network providers, broadband operators, cellular operators, interexchange entities, third-parties, users, or others. Diagnostics may provide feedback for network monitoring, and quality assurance. Diagnostics may be separate for different applications, users, locations, and times. Time of day information may be involved with diagnostics. In one or more embodiments, the combined management system may diagnose both Wi-Fi/broadband and cellular data, at both low layers (physical, link, network) and high layers (session, presentation, application). WAN and LAN side speed tests may be run with their results used as input. Diagnostics may be in terms of latency or delay.

In one or more embodiments, feedback is provided to application providers as to how well the Wi-Fi/broadband network and/or the cellular data network are transporting their applications to a particular user, user population, devices, or services. Another example is to assist an operator in performing Wi-Fi data offload.

In one or more embodiments, diagnostics may be presented in various presentation formats to users. The user may be shown how well their applications are being supported, with a simplified presentation. For example, the user may be notified about how well Wi-Fi or cellular data can support different applications or an aggregated set of applications. An intuitive display such as simple red/green/yellow coloring can be understandable to the user. This can be shown at various times and locations. For example, data may be analyzed and stored over a long timescale, or data analyzed to determine trends across time-of-day, week or other time periods. The ability of functions to support applications on or across the different networks may be shown. For example, the user may be shown how particular roaming or traffic routing functions are behaving. Diagnostics may be across multiple Open Systems Interconnection (OSI) layers, multiple provider domains, and multiple services.

### Embodiments of Configuration or Re-configuration

In one or more embodiments, the combined management system may determine how to configure, or re-configure, the settings used to control applications, services, devices, network, links, servers, service origination functions, etc. Policies, objects, parameters, settings, profiles, and network control may be configured. The system may provide control and configuration at different levels: from policies, to management settings, to networking forwarding control. The system may provide configuration of both Wi-Fi/broadband and cellular data, a both low layers (physical, link, network) and high layers (session, presentation, application).

In one or more embodiments, the system may present configuration choices or recommendations to users, allowing the user to select how they may improve their experience, for example by allowing increased or decreased data usage. The system may let the user select which services to discontinue or to de-emphasize, e.g., to allow background tasks such as software updates to be deferred until a time of low traffic or to move these background tasks to a lower cost network.

In one or more embodiments, configurations may allow a user to select: Wi-Fi, cellular data, both Wi-Fi and cellular data, or auto-switching between Wi-Fi and cellular. The auto-switch may be implemented based on whether one or more criteria are met. With auto-switching, a user may control a hysteresis level or frequency of occurrence of switching between Wi-Fi and cellular. Configuration may be aimed at achieving a QoE level for one or more applications, minimizing bandwidth usage, minimizing bandwidth availability, ensuring seamless connectivity, or maximizing user utility. A traffic descriptor may be used for part of policy, data, or configuration. Some percentage of bandwidth may be apportioned across Wi-Fi or cellular data.

In one or more embodiments, the system may directly or indirectly control: allocation of bandwidth to cellular or Wi-Fi, Broadband bandwidth allocation (including DSL, Coax, PON, virtual Dynamic Bandwidth Allocation (vDBA), by steering Wi-Fi station (STA) to Access Point (AP) associations, channel assignments, priority, OFDMA assignments, Basic Service Set (BSS) colorings, bandwidth allocations, the mapping of Wide Area Network (WAN) Virtual Local Area Networks (VLANs) or Diff Serve Code Point (DSCP) markings to LAN priorities/VLANs. End-to-end VLANs can be set up. The system can be used in conjunction with Wi-Fi channel/band selection, associations, client steering, Dynamic Frequency Selection (DFS) channel usage, Citizens Band Radio Service (CBRS) usage, and License Assisted Access (LAA).

### Embodiments of Optimization

In one or more embodiments, the determination of network, device and application setting comprises an optimization process using one or more criteria. User perceived service quality is generally the optimization criterion, however, other sub-criteria may be optimized toward that goal, including but not limited to:
Data rate, possibly subject to meeting service requirements.
Latency: minimized latency for some applications by using the lowest latency path;
Stability of the delivered transport or service;
User-perceived QoE;
Value to the end user accounting for pricing or another utility function.

In one example: Station (STA) or User Equipment (UE) 1 is steered to support streaming across high speeds, while STA/UE 2 is steered to have a stable, uninterrupted connection at lower speed; and can be limited by broadband rate caps. This may include steering or load balancing between associated devices, channels, bands and between Wi-Fi and Cellular.

In another example: continuous connectivity may be provided by handing off cellular and handing off Wi-Fi at different times. Alternatively, a main signal path and an ancillary signal path may be selected, e.g., the main path is cellular data with good cellular coverage, or the main path is WLAN if WLAN is fast and stable.

In one or more embodiments, optimization may be to the user, device, service, or application. In one or more embodiments, optimization may be implemented for joint Wi-Fi, broadband and cellular latency, data rate, or data delivery.

In one or more embodiments, the optimization process may use Ergodic Spectrum Management (ESM) techniques, including stage 1, 2, and 3 ESM. The optimization process may further extend to partial Orthogonal Frequency Division Multiple Access (OFDMA), and using separate Modulation and Coding Schemes (MCS) in separate bands. Optimization may also extend to Coordinated MultiPoint (CoMP).

### Embodiments of Location and Type of Use

In one or more embodiments, the system may identify the type of use of the broadband service and mobility trajectory of the user. These data may then be used to determine whether to use Wi-Fi or cellular data, or how much of each to use, and when to handoff between Wi-Fi and cellular data or between access points. Location information taken over time may be used to determine user trajectory. Wi-Fi sensing and similar techniques may be used to determine particular usage types for a user is consuming a service; e.g., standing or sitting indicates active use or passive use. Trajectory may also be determined by Wi-Fi sensing.

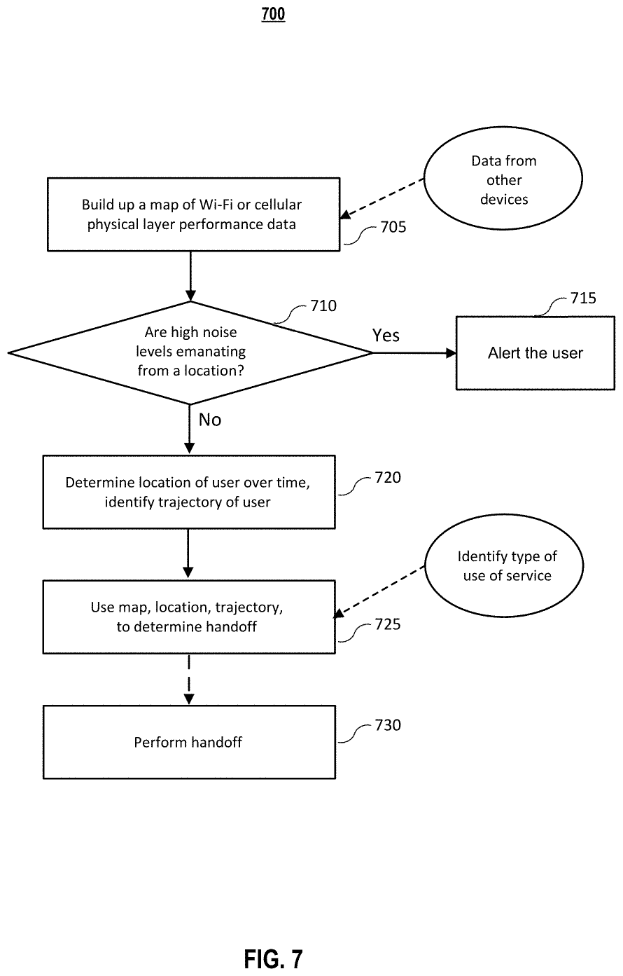

FIG. 7 shows a flow chart for a location-based combined management system according to various embodiments of the invention. In step 705, a map of Wi-Fi performance and cellular performance data is built up over time as users move and roam. The map may show signal strength, interference, noise, data rate, modulation and coding (MCS) or other physical layer performance data. The map may be stored in the cloud and used for multiple users. The map may be used to determine whether to use Wi-Fi or cellular data, or how much of each to use, and when to handoff between Wi-Fi and cellular data or between access points. In one or more embodiments, data from other devices or third-parties may also be used in building the map of Wi-Fi performance and cellular data performance. In one or more embodiments, the map of Wi-Fi performance and cellular performance data comprise performance data for cellular networks or Wi-Fi networks to which the mobile device is not currently connected.

Parts, or variants, of the map may be used to enhance the system. For example, the map may comprise neighbor networks that the mobile device may get a connection soon based on moving trajectory of the user. Alternatively, the map may comprise networks within connection range of the mobile device but not currently getting connected; and those currently unconnected networks may be connected to the mobile device anytime shall the performance of a currently connected network be not satisfactory.

In step 710, the system may determine whether high noises are emanating from a location. If yes, the user is alerted in step 715. Otherwise, the system determines locations of the user overtime and may identify a trajectory of the user in step 720. The trajectory may be identified based on at least one of user historical data, user motion patterns (speed, direction, etc.), the map of Wi-Fi performance and cellular data performance, Wi-Fi sensing, and mobile device status (e.g. signal strength, battery power level), etc.

Based on the map of Wi-Fi performance and cellular data performance, current location of the user, and/or the determined trajectory, a handoff is determined in step 725 and then the determined handoff is performed in step 730. In one or more embodiments, determining the handoff also involves identifying the type of use of service, e.g. applications security requirement, Wi-Fi security level, authentication status, etc.

Although FIG. 7 shows handoff in the flow chart for a location-based combined management, one skilled in the art shall understand that, instead of a handoff, other types of re-configuration actions, such as flow/packets re-balance, partial offload from one network to another network, etc. may also be implemented using the location or trajectory based management method. Such variations shall still be within the scope of this invention.

In one or more embodiments, a map of interference or noise may be created. Such a map of interference or noise may be used in analyses to identify devices that are creating high noise levels, such as malfunctioning light ballast. The user may then be alerted about the malfunctioning device, with a recommendation to replace it, and giving the location of the malfunctioning device.

### Embodiments of Application-driven Combined Management

In one or more embodiments, applications, or equivalently services, may drive both the context for diagnostics and the recommendations for configurations. Different applications have different user priorities and different requirements for data rates, connectivity, availability, reliability, latency, jitter or buffering, and error tolerance such as packet loss rates. These requirements may vary over time both per application and in the aggregate across multiple applications. The system may account for these application needs both in determining diagnostic impact and in recommending re-configuration.

An illustrative example is a conversational voice application, which has low data rate requirements but needs low latency and what appears to the user as seamless connectivity. To achieve this, depending on policies, voice may be prioritized over other services. Alternatively, voice traffic may be supported by using simultaneously both Wi-Fi and cellular, or by steering between cellular data and Wi-Fi rapidly, or by minimized steering with steering only when voice cannot be supported on a link.

In another example, video or other file sharing or social media applications may be delivered at the highest picture quality over a high data rate. Alternately, a lower picture quality may be tolerable which allows use of a lower data rate to allow redundant delivery across both Wi-Fi and cellular to support low delay and more seamless user experience. Video quality may be traded for data rate usage simply for billing or other purposes. Cellular data usage may be deferred times of better conditions or lower pricing.

### Embodiments of Multipath, Load Balancing, and Failover

In one or more embodiments, traffic may be routed or steered across broadband Wi-Fi or cellular data networks using many techniques, which may be controlled by the system. Data may be routed, switched, and apportioned across the Wi-Fi and cellular data links. Control functions, and data-plane switching, may be performed and controlled per-packet, per-flow, per-application, per-device, or per-user. A flow may exist for a given application or for particular end-points. Traffic may be sent over diverse links for redundancy, and routed across running links for failover.

In one or more embodiments, data flows may be multi-homed across both Wi-Fi and cellular. Multi-link bonding, load balancing, scheduling and aggregation may be performed. Multipath access may send data across both Wi-Fi and cellular data links, and across multiple Wi-Fi, cellular data, and wired links. Data may be similarly switched or apportioned across multiple bands or channels of Wi-Fi or of cellular data. This may be done in both traffic directions: upstream and downstream, or uplink and downlink. Traffic prioritization and separation can be configured. Multipath TCP (MPTCP) can be controlled by the system.

In one or more embodiments, aggregation may be performed at the Ethernet layer, IP layer, session layer, application layer, or Packet Data Convergence Protocol (PDCP) layer. Route flapping, or changes in data paths, may be limited or controlled. Hybrid access may be used with an HCPE, and optionally a network-located Hybrid Access Gateway (HAG).

In one or more embodiments, the combined management system may assist with real-time adaptation to variations in transmission environments, traffic, and to users bringing applications up and down.

### Embodiments of Roaming

In one or more embodiments, the system may assist with managing roaming; between networks of the same type and across heterogeneous networks such as roaming between Wi-Fi/WLAN and cellular networks. Roaming may optimize connectivity and connections for services requiring no interruptions; including voice, streaming, tele-operations and vehicle communications (V2X).

In one or more embodiments, roaming may be performed in response to service caps, for example to switch to Wi-Fi when a cellular data allocation is used up. Roaming can be configured to provide a seamless user experience. Roaming may respond to mobility, for example by automatically steering a device to be associated to a different access point (AP) or base station. Approach to the edge of coverage may be detected, and roaming initiated at the correct time or place, for example to transition among ESS, BSS, or cellular/Wi-Fi.

In one or more embodiments, roaming may involve 4G/5G and Wi-Fi/WLAN multipath access, and multi-band operation. Roaming may control steering, switching and selection of communication paths. The system may interface with, diagnose, and control roaming methods including: Wi-Fi Roaming Standard (Wireless Broadband Alliance (WBA) WRIX), Passpoint, Hotspot, Global System for Mobile Communications Alliance (GSMA), Wi-Fi Alliance Wi-Fi Agile Multiband™, Wi-Fi Alliance Wi-Fi Optimized Connectivity™, Wi-Fi Alliance EasyMesh™, Wi-Fi Alliance Wi-Fi Aware™, and Fast Session Transfer (FST).

In one or more embodiments, the system may assist the diagnostics and configuration of technologies used in various embodiments previously discussed, including: LTE-WLAN aggregation (LWA), Licensed Assisted Access (LAA), Multipath TCP (MPTCP, IETF RFC 6824), Access Traffic Steering, Switching and Splitting (ATSSS), Session Management Function (SMF), Policy Control Function (PCF), Multipath Quick UDP Internet Connection (MP-QUIC), and Software Defined Networking (SDN) control.

The system may work in conjunction with Wi-Fi diagnostics and optimization systems and software, including cloud-based and agent-based systems. The system may also work with broadband diagnostics and optimization systems and software.

### Embodiments of Infrastructure

In one or more embodiments, the system may be implemented as software running on servers or cloud or edge computing infrastructure, or as software apps or agents on running on network elements, Customer Premises Equipment (CPE), user equipment, or devices. Computing may be distributed across devices and the cloud. Software apps or agents can work in conjunction with cloud controllers. Software may be supported and linked across multi-AP mesh networks or extenders within a domain.

Devices supported may include a Smartphone, a laptop, tablet, IoT device, personal computer (PC), a tablet PC, a set-top box (STB), a Personal Digital Assistant (PDA), a cellular telephone, a web appliance, a server, a network router, switch or bridge, computing system, or any machine capable of executing a set of instructions (sequential or otherwise) that specify actions to be taken by that machine. The system may work across multiple provider domains and multiple compute infrastructures.

### Additional Embodiments

In one or more embodiments, the system may diagnose and/or optimize the downlink, uplink, or both. Millimeter (mm) wave and sub-6 GHz bands may be used. The system may diagnose and/or optimize a Heterogeneous Network (HetNet). The system may manage session mobility, and can provide unified authentication.

In one or more embodiments, the system may further employ LTE WLAN integration with IPsec tunnel (LWIP). The system may support Non-Stand Alone (NSA) or Stand Alone (SA) configuration. The Non-3GPP Interworking Function (N3IWF) can be used to enable Wi-Fi integration into the 5G Core Network. The CNG may be embodied as an Access Gateway Function (AGF). The WLAN and cellular networks may connect to the core network through an AGF, Fixed Mobile Interworking Function (FMIF), or Hybrid Access Gateway (HAG). Control may be via the Control and User Plane Separation (CUPS) protocol. The system may further involve diagnostics and optimization of one or more network slices, and diagnose and control the management of network slices.

In one or more embodiments, the system may involve multiple network technologies, including Third Generation (3G), 4G, 5G, Long-Term Evolution (LTE), LTE advanced, New Radio (NR). Evolved Packet Core (EPC), 5G Core Network (SGCN), Wi-Fi, Wireless LAN (WLAN), Low Power Local Area Network (LoRAN), Wired LAN, Ethernet, Powerline networks, Multimedia over Coax Alliance (MoCA), G.fast, and G.hn.

In one or more embodiments, the system may be applied with Access Centric integration, Core Centric integration, Non-core centric integration, and Above the Core integration. The system may use a Socket Secure (SOCKS) proxy. The system may provide Multi-Access Management Service (MAMS).

In one or more embodiments, the system can input and provide diagnostics related to Broadband Quality Experience Delivered (QED), or Quality Attenuation for Broadband Networks. The system may work across multiple devices or applications, for example to support application displays as they move across different display terminals.

Applying the above described systems and methods, one skilled in the art will recognize that variations of the disclosed systems and methods may be applicable for combined management for two or even more wireless communication modes. One skilled in the art will recognize that those variations may benefit from the system and method embodiments disclosed in the present document. The foregoing description of the invention has been described for purposes of clarity and understanding. It is not intended to limit the invention to the precise form disclosed. Various modifications may be possible within the scope and equivalence of the appended claims.

It is intended that all permutations, enhancements, equivalents, combinations, and improvements thereto that are apparent to those skilled in the art upon a reading of the specification and a study of the drawings are included within the true spirit and scope of the present disclosure. It shall also be noted that elements of any claims may be arranged differently including having multiple dependencies, configurations, and combinations.

1. A method for management of data delivery, the method comprising:
collecting wireless local area network (WLAN) conditions for a WLAN and cellular network conditions for a cellular network;
performing one or more analyses using one or more conditions from the collected WLAN conditions and cellular network conditions;
receiving one or more high-level policies which specify one or more user preferences for performance of one or more applications operating on the device;
determining one or more network policies, network settings, device settings or application settings using the one or more analyses and the one or more high-level policies; and
assigning one or more flows or packets between the cellular network and the WLAN for the device using the one or more network policies, network settings, device settings or application settings.

2. The method of claim 1 wherein the WLAN is a Wi-Fi network.

3. The method of claim 1 wherein the one or more analyses comprise joint analyses, performing the joint analyses comprising at least one of:
identifying operation of connections between the mobile and the cellular network and the WLAN;
identifying quality of these connections; and
identifying performance of applications running on these connections relative to the quality of the two connections.

4. The method of claim 1 further comprising:
performing analyses to provide configuration recommendations as directed by the one or more policies.

5. The method of claim 1 wherein at least one of the one or more network or application settings provides simultaneous usage of both the cellular network and the WLAN network.

6. The method of claim 2 wherein the one or more policies of connection control comprise one or more of:
user-specified policies that prioritize different services or applications;
user-specified preferences for the perceived service delivery performance of one or more applications;
user specified preferred behavior if a service cap is reached or how to handle other pricing implications;
user quality of experience (QoE) preferences;
application-level indicators;
a threshold for using cellular data versus Wi-Fi;
assignment of service priorities;
a policy to select on the basis of traffic cost;
a policy to select or prefer cellular data versus Wi-Fi depending on usage caps, data charging, relative costs; and
a policy for soft selection of a relative desire to use cellular data versus Wi-Fi.

7. The method of claim 1 further comprising:
determining one or more of: low-level network policy, network configuration parameter settings, or services configuration parameter settings based on the one or more policies.

8. The method of claim 1 wherein the one or more policies are policies per application, or per class of applications.

9. The method of claim 3 wherein performing joint analyses comprises analyzing cellular network data and Wi-Fi network data over a timescale.

10. The method of claim 1 wherein the WLAN conditions and cellular conditions comprise diagnostics provided by application or service providers, network providers, broadband operators, cellular operators, interexchange entities, third-parties, network elements, or users.

11. The method of claim 2 wherein the collected WLAN conditions and cellular network conditions comprise configurations of one or more of Wi-Fi networks, broadband networks, cellular data networks, or aggregation of two or more networks.

12. The method of claim 10 wherein diagnostics are of both low Open Systems Interconnection (OSI) layers and high OSI layers.

13. The method of claim 1 wherein the one or more policies of connection control comprise at least one of: a target of achieving a quality of experience (QoE) level for one or more applications, minimizing bandwidth usage, minimizing bandwidth availability, ensuring seamless connectivity, or maximizing user utility.

14. The method of claim 1 further comprising:
directly or indirectly controlling, based on at least the determined network or application settings, one or more of allocation of bandwidth to cellular or Wi-Fi, broadband bandwidth allocation, Wi-Fi associations, channel assignments, priority, OFDMA assignments, Basic Service Set (BSS) colorings, bandwidth allocations, the mapping of WAN VLANs or DSCP markings to LAN priorities or VLANs.

15. The method of claim 1 wherein assigning flow or packets comprises roaming between networks of the same type or roaming between the WLAN network and the cellular networks.

16. The method of claim 2 wherein the one or more network policies regulate one or more of:
prioritizing voice over other services;
supporting voice traffic simultaneously over both Wi-Fi and cellular;
rapidly steering between cellular data and Wi-Fi; and
minimizing steering events.

17. A method for management over cellular network data and wireless local area network (WLAN) data for a mobile device, the method comprising:
specifying, by a user, one or more policies of connection control to specify one or more user preferences for one or more applications operating on the mobile device;
determining one or more network policies, network settings, or application settings based at least on the one or more policies;
assigning one or more flows or packets for the mobile device between a cellular network and a WLAN coupled to the mobile device for implementation based at least on the determined one or more network policies, network settings, or application settings; and
determining whether wireless communication services with the assigned one or more flows or packets are satisfactory;
in response to the wireless communication services are satisfactory, continuation operation of the mobile device with the determined one or more network policies, network settings, or application settings;
in response to the wireless communication services are not satisfactory, re-determining one or more network policies, network settings, or application settings.

18. The method of claim 18 wherein the determining whether wireless communication services with the assigned one or more flows or packets are satisfactory is based on latency, error rate, or a combination of both.

19. A method for management over cellular network data and wireless local area network (WLAN) data for a mobile device, the method comprising:
establishing a map of Wi-Fi performance and cellular performance data for one or more cellular networks or one or more Wi-Fi networks;
determining location of a mobile device and identifying a trajectory of the mobile device;
determining a handoff, flow or packets re-balance, or partial offload from one network coupled to the mobile device to another network coupled to the mobile device based on the established map, current location of the mobile device, and the determined trajectory, and one or more policies of connection control specifying one or more user preferences for perceived service delivery performance of one or more applications operating on the mobile device; and
performing the determined handoff, flow or packets re-balance, or partial offload.

20. The method of claim 19 wherein the one or more policies are specified by a user of the mobile device, and comprise one or more of:
user-specified policies that prioritize different services or applications;
user-specified preferences for the perceived service delivery performance of one or more applications;
user specified preferred behavior if a service cap is reached or how to handle other pricing implications;
user quality of experience (QoE) preferences;
application-level indicators;
a threshold for using cellular data versus Wi-Fi;
assignment of service priorities;
a policy to select on the basis of traffic cost;
a policy to select or prefer cellular data versus Wi-Fi depending on usage caps, data charging, relative costs; and
a policy for soft selection of a relative desire to use cellular data versus Wi-Fi.
